(19) United States
(12) Patent Application Publication
(10) Pub. No.: US 2024/0239349 A1
(43) Pub. Date: Jul. 18, 2024

(54) MODE OF EXPERIENCE-BASED CONTROL OF A SYSTEM

(71) Applicants: GM GLOBAL TECHNOLOGY OPERATIONS LLC, Detroit, MI (US); B.G. Negev Technologies and Applications Ltd. at Ben-Gurion University, Beer-Sheva (IL)

(72) Inventors: Asaf Degani, Tel Aviv (IL); Yael Shmueli Friedland, Tel Aviv (IL); Zahy Bnaya, Tel Aviv (IL); Christine Ebner, Calabasas, CA (US); Guy Cohen-Lazry, Kiryat Ono (IL); Tal Oron-Gilad, Nir-Moshe (IL)

(73) Assignees: GM GLOBAL TECHNOLOGY OPERATIONS LLC, Detroit, MI (US); B.G. Negev Technologies and Applications Ltd. at Ben-Gurion University, Beer-Sheva, MI (IL)

(21) Appl. No.: 18/096,282

(22) Filed: Jan. 12, 2023

(51) Int. Cl. B60W 40/08; B60W 50/16; B60W 60/00; G06V 20/59

(52) U.S. Cl. CPC B60W 40/08; B60W 50/16; B60W 60/00; G06V 20/59; B60W 2540/22

(57) ABSTRACT

A system, e.g., an autonomous vehicle, includes a sensor suite, a controller, and a computer-controllable device. The sensor suite collects user data descriptive of the present emotional state of a human user, such as a passenger of the representative autonomous vehicle. The controller executes a method to control the system. In particular, the controller identifies the user's psychological mode of experience in response to the user data. The controller also selects one or more intervening control actions or “interventions” from a list of possible interventions based on the mode of experience, and then controls an output state of the device to implement the intervention(s). In this manner the controller is able to support or modify the mode of experience of the user.

### INTRODUCTION

Modern motor vehicles are configured with one of several different levels of automation control capability. As defined by the Society of Automotive Engineers and adopted by the United States Department of Transportation, there are six levels of driving automation, nominally referred to as Levels 0, 1, 2, 3, 4, and 5 for simplicity. Traditional “non-automated” control (Level 0) requires a driver/operator to perform the primary driving tasks of acceleration, braking, and steering. Beginning with Level 1 automation, however, the driver's central role in controlling the primary driving tasks begins to incorporate progressively higher levels of controller-based decision making and actuation. Level 5 automation (“full automation”) effectively reduces the active role of the human driver to a passive one, i.e., that of a traditional passenger.

Human drivers/vehicle operators have traditionally acted as the central and often sole decision maker when performing the above-noted primary driving tasks. As a result, the experience of riding in a partially-automated (Level 1, 2), automated (Level 3, 4) or a fully-automated (Level 5) vehicle may affect the passenger's present emotional state, sometimes in unpredictable ways. A passenger of such vehicles could experience a range of emotional responses to the vehicle's control actions. For example, the passenger could experience psychologically uncomfortable feelings such as anxiety, stress, frustration, or resentment. Underpinning this complex array of human emotions is the need for the individual to surrender primary decision authority for a host of vehicle functions to an onboard computer system, and moreover, to trust the automated system's ability to correctly decide and quickly respond to rapidly changing drive conditions.

### SUMMARY

The automated solutions described herein are collectively directed toward improving the overall experience of a user of an automated system, exemplified herein as a partially-automated (Level 1, 2), automated (Level 3, 4), or fully-automated (Level 5) vehicle, having one or more machine-user interfaces. Users of the representative vehicle include one or more passengers. The present teachings could be applied to various vehicle types such as motor vehicles, aircraft, watercraft/boats, rail vehicles, etc., as well as to non-vehicular/stationary systems, regardless of whether they are automated, autonomous, or controlled in a completely manual manner.

Within the scope of the present disclosure, an onboard control system (“controller”) is trained with a psychoanalytic approach to help capture and assess a passenger's present psychological position, or “mode of experience,” as described in detail herein. By applying validated psychoanalytic processes aimed at subconscious portions of the passenger's “experiences,” the controller is better able to understand, evaluate, and if necessary intervene to support or modify the passenger's mode of experience.

In particular, a system in accordance with one or more disclosed embodiments includes a device having a computer-controllable function or functions, a sensor suite, and a controller. The sensor suite is positioned in proximity to the user, and is configured to collect user data descriptive of the present emotional state of a human user. The controller, which is in remote or direct communication with constituent sensors of the sensor suite, is configured to receive the user data. In response to the user data, the controller classifies the present emotional state of the user as an identified “mode of experience.” The controller then selects one or more intervening control actions or “interventions” from a rank-ordered list of possible interventions. The interventions for their part are configured to support or possibly modify the mode of experience. The controller thereafter controls an output state of the device(s) to implement the intervention(s), and to thereby affect the mode of experience of the user, such as by supporting or changing the mode of experience.

The system in one or more embodiments may be an autonomous vehicle. In such an implementation, the user is a passenger of the autonomous vehicle and the device is a subsystem or a component of the autonomous vehicle. The one or more interventions may include modifying an autonomous drive style of the autonomous vehicle.

The identified mode of experience in accordance with the present disclosure may be a sensory mode, a dichotomous mode, or a complex mode.

The controller in this exemplary system may be configured to control the output state of the device by changing the one or more interventions when the identified mode of experience has remained unchanged for a calibrated duration. Additionally, the controller may determine if changing the one or more interventions succeeded in changing the identified mode of experience into a new mode of experience. The controller may then support the new mode of experience using one or more additional interventions.

The interventions as contemplated herein may include an audible, visible, visceral, and/or tactile interaction with the user.

An aspect of the disclosure includes the sensor suite having one or more sensors operable for collecting images of the user. The controller may then process the images of the user through facial recognition software and a reference image library to classify the present emotional state of the user as the identified mode of experience.

Another aspect of the disclosure includes a method for controlling a system, e.g., an autonomous vehicle as summarized above. The method in one or more embodiments includes collecting user data using a sensor suite positioned in proximity to a human user of the system, with the user data being descriptive of a present emotion state of the human user. The method may also include receiving the user data via a controller. In response to the user data, the method further includes classifying the present emotional state of the user as an identified mode of experience, selecting one or more interventions from a list of possible interventions based on the identified mode of experience, and controlling an output state of a computer-controllable device of the system. This occurs by implementing the one or more interventions, including selectively supporting or modify the identified mode of experience of the user.

An autonomous vehicle is also disclosed herein having a vehicle body, a powertrain system configured to produce a drive torque, and road wheels connected to the vehicle body and the powertrain system. At least one of the road wheels is configured to be rotated by the drive torque from the powertrain system. The autonomous vehicle also includes a sensor suite configured to collect user data indicative of a present emotional state of a passenger of the autonomous vehicle, and a device having a computer-controllable function or functions. A controller in communication with the sensor suite receives the user data. In response to the user data, the controller in this embodiment is configured to classify the present emotional state of the passenger as an identified mode of experience, i.e., as a sensory mode, a dichotomous mode, or a complex mode, and to select one or more interventions from a list of possible interventions based on the identified mode of experience. The controller ultimately controls an output state of the device to implement the intervention(s), and to thereby selectively support or modify the identified mode of experience of the passenger.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 schematically illustrates a representative autonomous vehicle having a vehicle interior for transporting one or more passengers, and including a controller configured to assess each passenger's respective present emotional state, classify the passenger's mode of experience, and thereafter use the mode of experience in the overall control of the autonomous vehicle.

FIG. 2 is a schematic illustration of a representative passenger of the autonomous vehicle depicted in FIG. 1 and a sensor suite operable for informing a controller of the autonomous vehicle of a present emotional state of the passenger.

FIG. 3 is a diagram illustrating three different modes of experience in accordance with an aspect of the disclosure.

FIG. 4 is a table describing an application of the modes of experience of FIG. 3 across multiple possible interventions.

FIG. 5 is a time plot of representative measurements and interventions in accordance with an aspect of the disclosure.

FIG. 6 is a flow chart describing a method for controlling an autonomous system using mode of experience-informed decisions, as described in detail herein.

The appended drawings are not necessarily to scale, and may present a simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments may be arranged in a variety of configurations. Thus, the following detailed description is not intended to limit the scope of the disclosure as claimed, but is merely representative of possible embodiments thereof. In addition, while numerous specific details are set forth in the following description to provide a thorough understanding of various representative embodiments, some embodiments may be capable of being practiced without some of the disclosed details. Moreover, in order to improve clarity, certain technical material understood in the related art has not been described in detail. Furthermore, the disclosure as illustrated and described herein may be practiced in the absence of an element that is not specifically disclosed herein.

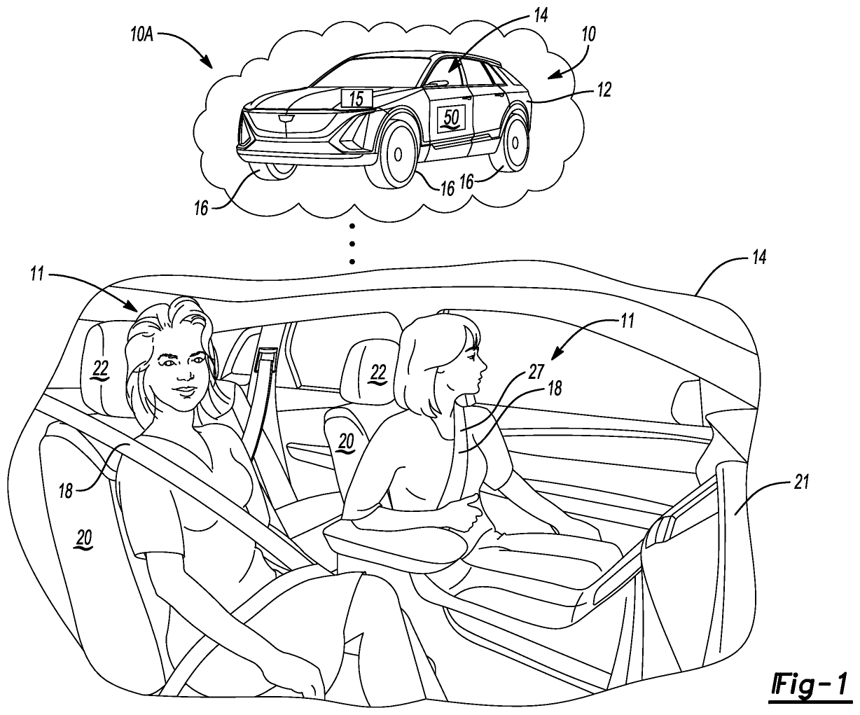

Referring to FIG. 1, a system 10A is shown in a non-limiting configuration as an autonomously-controlled motor vehicle (“autonomous vehicle”) 10, e.g., a Level 5/fully-autonomous vehicle in a possible implementation. Other levels of autonomy may be contemplated herein, and therefore a Level 5 embodiment of the autonomous vehicle 10 is just one possible implementation. Alternative embodiments of the autonomous system 10A that may benefit from the present teachings include, e.g., airplanes and other aircraft, farm equipment, transport vehicles, trains and other rail vehicles, boats, watercraft, hospital beds, factory floors having automated machinery, etc. The particular device or devices having an autonomously-controllable function may vary with the construction of the autonomous system 10A, with several possible autonomously-controlled devices described in detail below. Solely for illustrative consistency, the autonomous system 10A will be described hereinbelow in its representative embodiment as the autonomous vehicle 10, without limitation.

The autonomous vehicle 10 as set forth in detail herein includes an electronic control unit (“controller”) 50 configured to assess an emotional response of a passenger 11 of the autonomous vehicle 10 as a psychological “mode of experience”. During an autonomously-controlled drive cycle of the autonomous vehicle 10, one or more of the passengers 11 are seated within a vehicle interior 14 while a powertrain system 15 generates drive torque and delivers the same to one or more road wheels 16. This may occur without participation of the passenger 11 to varying degrees, with essentially no involvement of the passenger 11 when operating with Level 5 autonomy.

In the non-limiting motor vehicle configuration of FIG. 1, the autonomous vehicle 10 includes a vehicle body 12 connected to the road wheels 16. The powertrain system 15 construction will vary with the configuration of the autonomous vehicle 10, which in turn could be embodied as a battery electric vehicle, a hybrid electric vehicle, a plug-in hybrid electric vehicle, an extended-range electric vehicle, a fuel cell vehicle, or a gasoline, diesel, compressed natural gas, or biofuel-powered vehicle in different constructions. The vehicle body 12 for its part may vary with the configuration of the autonomous vehicle 10, for instance as a sedan, coupe, pickup truck, crossover, sport utility vehicle, or other body style.

Autonomous driving functions of the autonomous vehicle 10, in particular when the autonomous vehicle 10 is configured as a Level 5/fully-autonomous vehicle, may have a pronounced effect on the willingness of the passenger 11 to embrace use of the autonomous vehicle 10 and its underlying self-driving technologies. While much focus has been placed on the technological challenges of perfecting autonomous driving, e.g., real-time sensing, perception, and planning, the psychological experience of the passenger 11 has been largely overlooked. The present solutions are therefore directed to this aspect of the autonomous drive experience.

In particular, subjective “comfort” or “discomfort” of the passenger 11 on a psychological level tend to be user-specific and heavily modulated by the present psychological attitude and internal “mode of experience” of the passenger 11. The present disclosure, unlike existing onboard solutions, takes advantage of prevailing psychoanalytical theory by classifying the mode of experience of the passenger 11 when riding in the autonomous vehicle 10. The controller 50 may selectively intervene in the operation of one or more systems or functions of the autonomous vehicle 10 when needed, as described below, with such interventions possibly ultimately transitioning the passenger 11 from one mode of experience to another, and/or to better support or accommodate the passenger's emotional state during an unexpected dynamic vehicle event.

Intervening to change the mode of experience of the passenger 11 in the context of the present disclosure helps achieve a subjectively better and more authentic engagement with the surrounding “real world”. Theory, experiments, and clinical practice suggest that a passenger 11 that experiences being “stuck” for an extended period of time in a particular emotional position or mode of experience may experience feelings of discontent or resentment. This emotional response sometimes manifests hours or days after the actual experience. Controller-based interventions of the types contemplated herein ultimately aim to reduce the psychological discomfort of the passenger 11. This in turn should help to promote acceptance of autonomous technology and its myriad of potential user benefits.

With respect to the exemplary autonomous vehicle 10 shown in FIG. 1, the vehicle interior 14 may be equipped with one or more rows of vehicle seats 20, with each vehicle seat 20 being configured to support a respective passenger 11 when seated thereon. Each of the vehicle seats 20 may be attached to a corresponding head restraint 22 and equipped with restraint devices, including a seatbelt 18 and inflatable airbags (not shown). When the autonomous vehicle 10 is configured as a fully-autonomous motor vehicle as shown, the vehicle interior 14 may be characterized by an absence of traditional driver input devices, such as a steering wheel, brake pedal, accelerator pedal, etc. The passengers 11 could instead ride within the vehicle interior 14 in a largely passive manner, e.g., without performing driving functions such as steering, braking, and accelerating, and while facing toward (or possibly away from) an instrument panel 21. Embodiments of the autonomous vehicle 10 having less than full autonomy, however, could include one or more driver input devices such as the above-noted steering wheel and pedals, as appreciated in the art.

The controller 50 shown schematically in FIG. 1 is configured herein to apply psychoanalytic-based programming to the domain of human-machine interaction, which in this case encompasses audio, visual, visceral, and/or tactile interactions of passengers 11 with the autonomous vehicle 10. In particular, the controller 50 supports or changes an assessed mode of experience of the passengers 11 to minimize psychological discomfort of the passengers 11 during an autonomously-controlled drive event. This may or may not also entail increasing a level of physical comfort. Indeed, at times the commanded interventions could temporarily increase physical discomfort, e.g., by introducing alerts or dynamic responses, so as to “connect” the passenger 11 to the real world (e.g., other vehicles in the vicinity, jaywalking pedestrians, etc.)

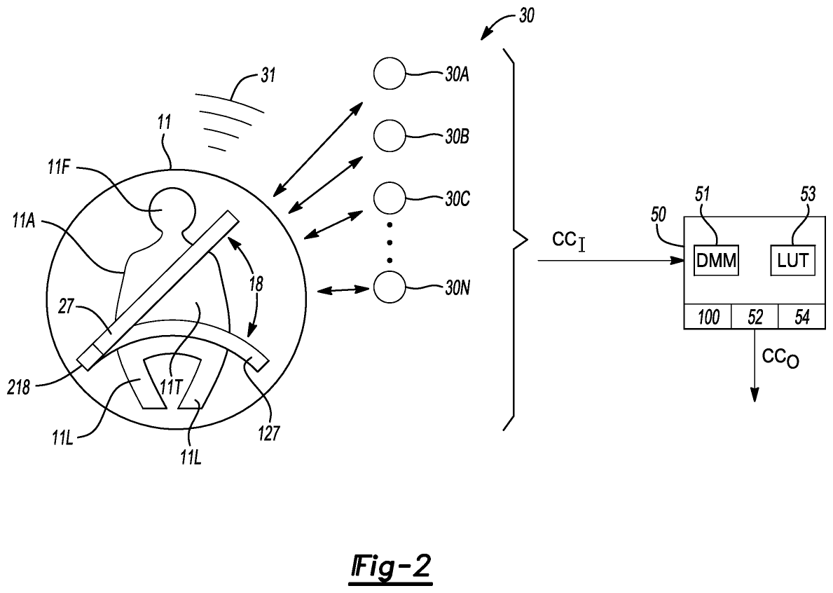

Referring briefly to FIG. 2, a respective passenger 11 when seated in the vehicle interior 14 of FIG. 1 may be secured to the vehicle seat 20 via the seatbelt 18, with the seatbelt 18 secured via a seatbelt buckle 218. In this position, a shoulder harness 27 of the seatbelt 18 extends over the occupant's shoulder as shown, with a lap belt 127 extending across the occupant's waist. In this upright seating position, the passenger 11 may be surrounded by constituent sensors of a sensor suite 30, with the sensor suite 30 being operable for monitoring various parameters of the passenger 11 and communicating measured, calculated, or estimated values to the controller 50 in the course of performing a method 100 as described in detail below.

As contemplated herein, the sensor suite 30 may include an occupancy sensor 30A operable for detecting the presence of the passenger 11 within the vehicle interior 14 of FIG. 1. Exemplary embodiments of the occupancy sensor 30A usable within the scope of the present disclosure may include weight sensors or scales, which in turn could be integrated into the vehicle seats 20 of FIG. 1. The occupancy sensor(s) 30A in alternative constructions could be remote sensors, e.g., visible spectrum or infrared cameras configured to detect the presence or absence of the passenger 11.

The sensor suite 30 may also include one or more position sensors 30B each positioned with respect to or surrounding the passenger 11 and/or designated body regions thereof, in particular a face 11F, arms 11A, torso 11T, legs 11L, etc. The position sensors 30B may collectively act as point cloud sensors operable for detecting multiple landmark points of interest on the passenger 11, including the face 11F, such that the position sensors 30B are able to discern facial expressions, body position, posture, and micro and macro movements of the passenger 11.

As appreciated by those skilled in the art, facial recognition software may be used herein to recognize the passenger 11 as being a specific user, i.e., from among a group of approved or predetermined users of the autonomous vehicle 10 of FIG. 1, and to recognize characteristic emotions of the passenger 11. To this end, commercially-available facial recognition software may be implemented as one or more algorithms or computer programs that the controller 50 could use to process digital video or still images of the passenger 11 when identifying or verifying the passenger 11, in this case collected by one or more cameras 30C of the sensor suite 30 depicted in FIG. 2.

When performing facial recognition functions, the controller 50 may compare unique characteristics to a calibrated database of reference faces, such as a reference image library. For instance, the controller 50 may compare a particular imaged face 11F or other features of the passenger 11 shown in the collected images to a library of faces, expressions, emotions, etc. For a given passenger 11, the controller 50 could compare the detected expression of the face 11F of the passenger 11 to past expressions, e.g., past expressions showing verified emotional states of the passenger 11. Given the complex and multi-faceted nature of human emotions, there is no exact number of emotions to be revealed by given individual's expression. However, the emotions, such as happiness, sadness, surprise, panic, anger, fear, and disgust may be demonstrated by the passenger 11 over time, and thus the controller 50 could continuously or periodically update a user profile for each passenger 11 as such emotions are detected and confirmed.

In general, the controller 50 of FIG. 1 may be configured to perform the facial recognition processes contemplated herein using traditional steps of preprocessing, detection, feature extraction, and feature comparison. During pre-processing, the controller 50 may process the collected user data (arrow CC_{I}) inclusive of video or still images of the passenger 11 to sharpen or improve the resolution of the image(s). Noise filters, lighting adjustments, image rotation, and other typical preprocessing steps may be performed during preprocessing. Feature detection involves the automated detection of the occupant's face 11F in the image(s), for instance using machine learning algorithms that in turn are trained using an image dataset. For example, when calibrating the controller 50 to perform the method 100, a given passenger 11 may be prompted to show different emotional states with facial expressions, with the controller 50 building an initial reference set or image library in the user profile.

Feature extraction may commence once the face 11F of the passenger 11 has been detected in the image(s) and reported to the controller 50 via the user data (arrow CC_{I}), with the controller 50 then extracting relevant facial features from the image(s), e.g., using a contoured grid overlay. Such features may include specific points on the face 11F, such as a distance between eyes of the passenger 11, the normal resting size and shape of the eyes, the size, shape, and orientation of the nose of the passenger 11, etc. Extracted facial features indicative of the emotional state of the passenger 11 may be compared to a library of the user's or other user's facial expressions, with the controller 50 thereafter using a typical comparison algorithm to determine whether the current image(s) correspond to a specific emotional state or mode of experience.

To that end, the sensor suite 30 of FIG. 2 may additionally include one or more additional sensors 30N. The additional sensors 30N may include, e.g., microphones each possibly including speakers for communicating audible speech, tones, or other information to the passenger 11. Such microphones are configured to detect speech 31 uttered by the passenger 11 and possibly encode the speech 31 as corresponding waveforms for further processing by the controller 50, as appreciated in the art of speech-to-text conversion software.

As part of the present control strategy, optional biometric sensors (not shown) could be used to detect additional parameters descriptive or indicative of a possible emotional state of the passenger 11, e.g., heart rate, perspiration level, body temperature, etc. Some of the additional sensors 30N may be configured to detect other parameters and/or operate in different manners within the scope of the disclosure. The sensor suite 30 ultimately outputs the user data (arrow CC_{I}) to the controller 50 as part of the present method 100, an example of which is described below with reference to FIG. 6. The controller 50 responds to the user data (arrow CC_{I}) by outputting control signals (arrow CC_{O}) to one or more vehicle components, devices, or subsystems of the autonomous vehicle 10 to selectively execute intervening control actions (“interventions”) in accordance with the method 100.

Still referring to FIG. 2, in order to perform the disclosed functions, one or more processors 52 of the controller 50 are configured to execute the present method 100 as algorithm or algorithms, with the method 100 possibly implemented as control logic or computer-readable instructions from memory 54. Such instructions may be stored in the memory 54, which may include tangible, non-transitory computer-readable storage medium, e.g., magnetic media or optical media, CD-ROM, and/or solid-state/semiconductor memory, such as various types of RAM or ROM. The term “controller” and related terms used herein such as control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.).

Also included in the architecture of the controller 50 include, e.g., input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions.

Non-transitory components of the memory 54 are capable of storing machine-readable instructions in the form of one or more software or firmware programs or routines, combinational logic circuit(s), input/output circuit(s) and devices, signal conditioning and buffer circuitry and other components that can be accessed by one or more processors 52 to provide a described functionality. To perform the method 100, the controller 50 may be programmed with a Decision Making Module (“DMM”) 51 and one or more lookup tables (LUT) 53, the applications of which are set forth below with reference to FIG. 6.

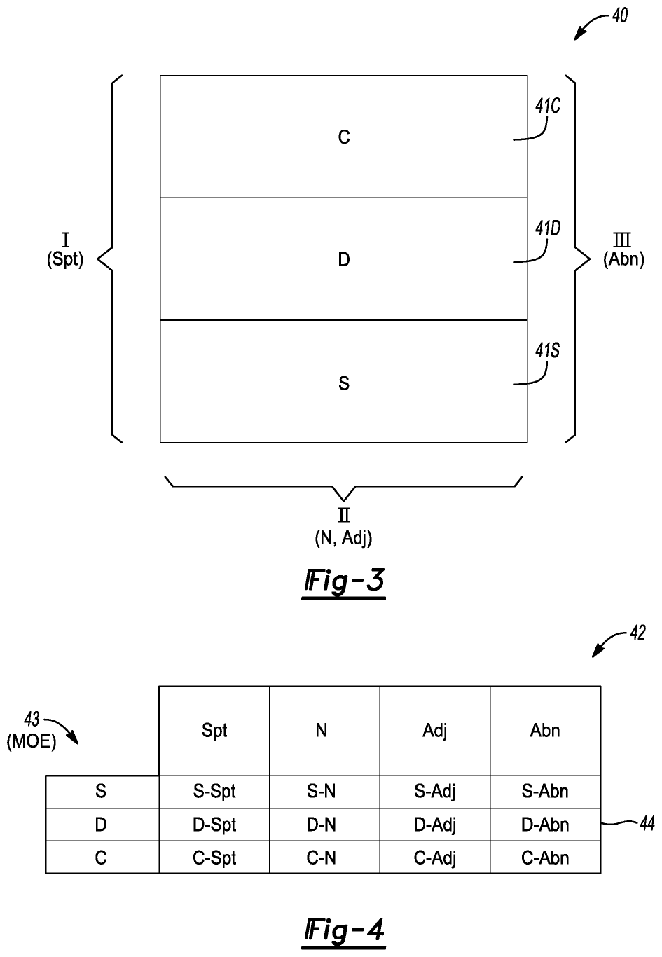

Turning now to FIG. 3, the relevant psychoanalytic theory of object relations applied herein proposes the use of psychological “modes of experience”. For example, the three modes of experience specified below could define how an individual mentally constructs a given experience. As depicted via a pyramid diagram 40, with sections C, D, and S representing “complex”, “dichotomous”, and “sensory”, respectively, the modes of experience may be referred to as a sensory mode 41S in which the experience is predominantly or exclusively sensory where there seem to be no other people (subjects) in the world, only objects, a dichotomous mode 41D in which a person's experience of other people in the world (i.e., subjects) is characterized into the binary extremities of “perfectly good” or “completely bad”, and a complex mode 41C in which the person's experience of other people in the world (i.e., subjects) becomes more considerate, realizing that other people can have both good and bad sides, and that relations with such people varies in accordance with their dynamic as well as time and situation.

People tend to transition between these modes of experience throughout the day in reaction to their internal emotional state, moods, feelings, and external situations. Since emotional states are the way human beings “engage with the world,” it is important for well-being that people transition between these experiences and not get “stuck” in any one mode of experience.

As contemplated herein, it is possible for the controller 50 of FIGS. 1 and 2 to quantitatively evaluate the psychological mode of experience of the passenger 11 in the overall control of the autonomous vehicle 10. For each respective one of the aforementioned modes of experience, a responsive intervention scheme chosen by the controller 50 is determined from a set of possible interventions, e.g., verbal, visual, audible, visceral, or haptic adjustments, and/or changes to the autonomous drive style of the autonomous vehicle 10 of FIG. 1, e.g., as a powertrain control action, a steering control action, a braking control action, etc.

Through selected interventions such as these, the controller 50 may support the present emotional state and mode of experience of the passenger 11, as indicated by Region I of diagram 40, nudge or adjust the person's mode of experience (Region II), and help the passenger 11 recover following an abnormal situation, e.g., a dynamic vehicle event such as a rapid or near-instantaneous deceleration or other event requiring deployment of airbags or other passenger restraints. Each of the aforementioned modes of experience will now be described in turn.

Sensory Mode: when the passenger 11 rides in the autonomous vehicle 10 of FIG. 1 while in the sensory mode 41S, the passenger 11 will have a pre-verbal experience, i.e., one that is sensory-oriented in terms of touch, rhythm, and intimacy. Such a person may be inwardly concerned with the multitude of sensory and sensual aspects of riding in the autonomous vehicle 10, e.g., possible accelerations, jerks, vibrations, road bumps, distance to other objects, etc., rather than with the computer-based “intentions” of the autonomous vehicle 10 and its resident controller 50.

While in sensory mode 41S of FIG. 3, the passenger 11 may strive to avoid experiencing nervousness or anxiety. Instead, the passenger 11 may attempt to preoccupy themselves with distracting or self-soothing techniques, such as but not limited to using their smartphone, talking aloud to themself, fidgeting, grooming, adjusting their clothing, etc. In this way, the passenger 11 is able to divorce their personal experience from the actions of the autonomous vehicle 10 and the resulting ride. The passenger 11 may also attempt to relate to signs of perceived ride safety, e.g., smoother turns, larger separation distances from proximate vehicles or objects, etc., so as to convince themself that the controller 50 is indeed functioning in a proper and secure manner.

Being in sensory mode 41S may also reflect on the communication style preference of the passenger 11. An inclination toward sensuous pre-language communication may imply that, during an unpleasant event such as a dynamic vehicle event resulting in an unexpected rapid acceleration or deceleration, or a sudden aggressive steering or braking maneuver, providing the passenger 11 with a real-time verbal explanation may increase anxiousness, whereas lowering the speed of the autonomous vehicle 10 and possibly adjusting to smoother dynamics—both examples of sensuous actions—may prove to be a more successful course of action.

Dichotomous Mode: this mode, i.e., 41D of FIG. 3, may involve a crude verbal experience and judgment-oriented or simplistic thinking that the autonomous vehicle 10 is objectively “good” or “bad”. The dichotomous mode 41D may involve rewriting historical information of past events—resulting in unstable object relations, which are at the mercy of momentary experiences. The passenger 11 may need the reinforcement of positive past experiences as a source of security, allowing the passenger 11 to deal with natural frustrations, particularly when the passenger 11 is challenged by new and possibly subjectively threatening events and relations. For this reason, additional attention may be required in the event one or more passengers 11 experience the ride through the unique lens of the dichotomous mode 41D.

As an example, one may suppose that, from the perspective of the passenger 11, the autonomous vehicle 10 of FIG. 1 performs a subjectively risky dynamic maneuver. The passenger 11 may feel that autonomous vehicle 10 is actively “trying” to damage itself or somehow inflict damage to another object. Previous experiences of so-called “good” behavior of the autonomous vehicle 10 may be assigned to a mental category of “good”, which in the person's subjective experience is falsely perceived as belonging to a different vehicle than the autonomous vehicle 10 whose controller 50 is currently in control. The fact that the autonomous vehicle 10 currently in control is subjectively characterized by the passenger 11 as being a “bad” vehicle may cause anxiety, and could lead the passenger 11 to perceive the autonomous vehicle 10 as having negative and potentially dangerous control intentions.

Complex Mode: in this mode, i.e., 41C of FIG. 3, the passenger 11 understands that the autonomous vehicle 10 has its own control intentions, and that such intentions are determined according to its own logic. As a result, the passenger 11 appreciates that the autonomous vehicle 10 may choose to act in accordance with one of many possible behaviors, despite the fact that the passenger 11 is not in control and cannot necessarily predict which action will be taken. The emphasis on the current behavior and actions of the autonomous vehicle 10 (sensory mode) and intentions thereof (dichotomous mode) now shifts toward the capabilities of the autonomous vehicle 10, questions of what the autonomous vehicle 10 is able to perceive through its sensor suite 30 of FIG. 2, and actions the controller 50 of FIG. 1 will ultimately compute and execute.

Since the autonomous vehicle 10 shown in FIG. 1 is neither completely good nor completely bad from the perspective of the passenger 11 while the passenger 11 is in the complex mode 41C, the passenger 11 does not take for granted that the autonomous vehicle 10 is somehow incompetent or omnipotent. Thus, it becomes clear to the passenger 11 that the controller 50 has good intentions, but that the capabilities of the controller 50 may be somewhat limited and situations in the real world can thwart or distort even the best and correct intentions. For a passenger 11 in this mode, it is therefore important to receive forward-looking information, such as about the way the autonomous vehicle 10 plans to negotiate such future events or the status of the autonomous vehicle 10 and its constituent components, e.g., which components or subsystems operate and their respective limitations.

Referring to FIG. 4, a table 42 illustrates the three above-summarized modes of experience (“MOE”) 43, i.e., sensory mode (S), dichotomous mode (D), and complex mode (C). Regions I, II, and III of FIG. 3 correspond to specific actions of the controller 50 based on the mode of experience 43. Ongoing or “normal” support (“Spt”) of casual needs of the passenger 11 of FIG. 1 could be maintained in Region I, e.g., with constant or periodic audible, visible, and/or tactile feedback inside of the vehicle interior 14. Such support could be provided for each of the modes of experience 43, i.e., S-Spt, D-Spt, and C-Spt. The possibility of intervening with “abnormal support” is also discussed below.

Alternatively, the controller 50 of FIGS. 1 and 2 could decide to prompt or nudge (“N”) the passenger 11 when in Region II of FIG. 3 to transition to a different mode of experience 43, i.e., S-N, D-N, and C-N. The associated nudging interventions could vary with the application, and would collectively act by suggesting a transition in (i.e., nudging), or actually transitioning (adjusting), the mode of experience of the passenger 11.

In Region III of FIG. 4 during abnormal (“Abn”) operations as noted above, the controller 50 could decide to help the passenger 11 recover from the abnormal braking, steering, stopping, or accelerating event. This action is represented in table 42 as S-Abn, D-Abn, and C-Abn to indicate that the various actions, i.e., support, nudging, adjusting, and abnormal support, could be carried out in each of the modes of experience 43.

By way of an example, various speech-based interventions for the above-described modes may be contemplated within the scope of the disclosure. In the sensory mode, spoken support interventions of the controller 50 of FIGS. 1 and 2 could be preceded by a short and soft chime, and may include using a soft or normal tone of voice and the use of sense-related words. Characteristic phrases may include “status check: full passenger comfort mode. Extra performance margins enforced”, “performance test completed. Results: OK”, or “uncomfortable situations identified; smoother driving style selected, increasing performance margins.”

Visual interventions used to offer support in the sensory mode should avoid presenting complex spatial or symbolic information. Additionally, visceral, or tactile support interventions in sensory mode could include applying light pressure via the seatbelt 18 of FIG. 2, e.g., via control of tension on a seatbelt tensioner (not shown), or perhaps tightening or adjusting an inflation and/or position of seat cushions of the vehicle seats 20, changing a position of or springing interior door handles (not shown), or applying rhythmic vibrations via the vehicle seats 20. The controller 50 could likewise support the sensory mode via ambient actions such as darkening window tinting or, if so equipped, introducing a calming scent to the vehicle interior 14. The driving style enforced to support the sensory mode could use extra performance margins for acceleration, deceleration, speed, gap settings, etc. Similarly, support interventions performed in the complex mode could include utterances such as “status check: urban driving. Reduced harm to passengers and pedestrians.”

In the dichotomous mode, nudge interventions have a goal of imparting to the user a sense of a “sound” system. Utterances by the controller 50 could become more verbose and factual, for example, and could possibly be preceded by a short and/or soft chime, and may include “built-in test complete; sensor performing at 100%.” If visual nudge interventions are used in this mode, such interventions could entail providing more detail, including predictive content of potentially threatening objects. Visceral or tactile nudge actions in the dichotomous mode could include transitioning to normal tension on the seatbelt 18 and/or normal positions or other settings of the vehicle seats 20, removing the aforementioned vibrations, etc. Driving style could remain governed by increased performance margins as with the sensory mode described above.

In a similar vein, nudge interventions during the complex mode could include utterances such as “traffic density above anticipated levels; considering route changes”, or “is there anything about the driving experience that you would like to change?”. With respect to adjust-type interventions, this may occur in sensory mode by uttering phrases such as “identified several abnormal road situations. Do you feel uncomfortable in them?”, while in complex mode, the controller 50 could utter a phrase such as “identified several abnormal road situations. Modifying driving policy to better accommodate the situation.”

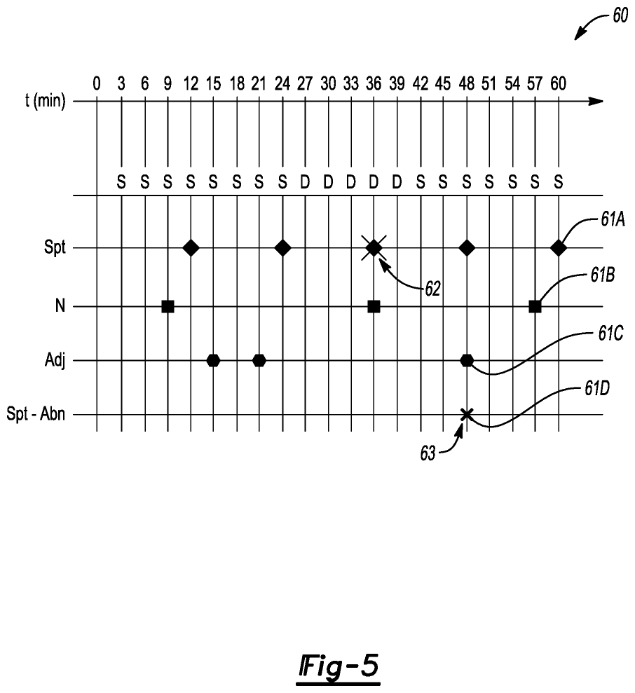

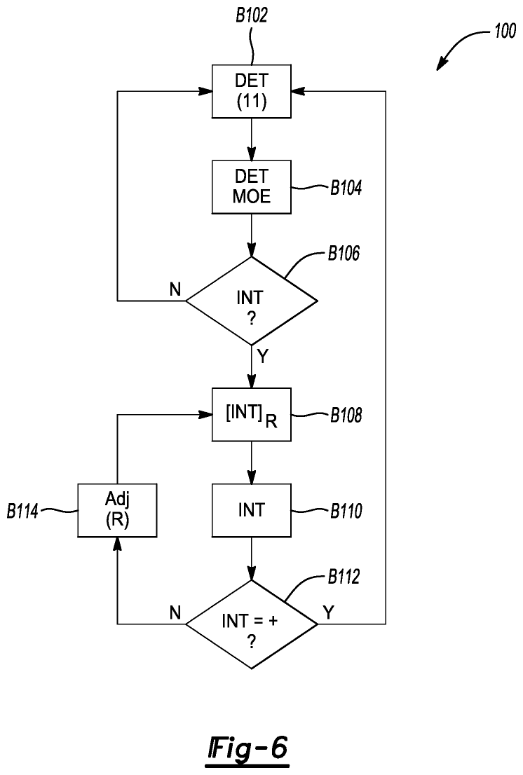

Turning now to FIG. 5, a representative time plot 60 illustrates using data points 61A, 61B, 61C, and 61D, the above-described actions of support (“Spt”), abnormal support (“Abn-Spt”), nudge (“N”), and adjust (“Adj”) in a timeline, with time (t) in minutes (min). In this non-limiting scenario, the controller 50 samples the user data (arrow CC_{I}) of FIG. 2 every three minutes, with other sample intervals being optional when implementing the method 100. Time plot 60 represents a hierarchy of sorts in which one type of action by the controller 50 could be preempted by another intervention. For example, supporting actions may be scheduled to occur every 12 minutes as an exemplary calibrated interval, unless another intervention is executed. If the passenger 11 is “stuck” in the same mode of experience for longer than the calibrated duration, i.e., the identified mode of experience of the passenger 11 has remained unchanged for the calibrated duration, the controller 50 could command a nudge intervention. This occurs in the representative example of FIG. 5 at t=9 min, 36 min, and 57 min.

In the exemplary scenario of FIG. 5, the controller 50 cancels the supporting action at t=36 min, as represented by data point 62, due to the nudge intervention scheduled at the same time. That is, nudge and adjust interventions have a higher priority than a scheduled support intervention. An abnormal support intervention has the highest priority as indicated by data point 63 at t=48 min, with this action cancelling or preempting the support and adjust interventions scheduled for the same time. Commencing at a predetermined time, e.g., after 6 min of the nudge intervention, if the passenger 11 has not changed their mode of experience, the controller 50 could respond by executing an adjust intervention. This is represented at t=15 min. Note that the mode of experience remains in sensory mode (S) until t=24 min. Therefore, the controller 50 commands another nudge intervention at t=21 min, possibly a different nudge action than that which was executed at t=15 min. This second nudge intervention is in response to the lack of a resulting change in the occupant's mode of experience between t=15 min and t=21 min.

As shown in FIG. 5, the mode of experience of the passenger 11 changes from sensory (S) to dichotomous (D) at t=27 min, and thus support interventions continue. Another nudge intervention is commanded at t=36 min, this time having the desired effect as the mode of experience transitions to the sensory (S) mode at t=42 min. The mode of experience remains in this state from t=42 min until t=57 min, prompting a third nudge intervention at t=57 min, which in turn produces the desired transition to another mode of experience, i.e., from the sensory (S) mode to the complex (C) mode at t=60 min. Thus, the actions of Regions I, II, and III of FIG. 3 as described in further detail with reference to FIG. 4 may follow an execution hierarchy within the scope of the present disclosure.

Referring now to FIG. 6, the method 100 is described in terms of possible steps or terminal/logic blocks. As used herein, the term “block” refers to programmed logic, computer-readable code, algorithm(s), or subroutine(s) used by the controller 50 to implement the corresponding functions. In general, the controller described above is configured to receive the user data (arrow CC_{I} of FIG. 1) from the sensor suite 30 of FIG. 2. In response to the received data set, the controller 50 identifies a mode of experience of the passenger 11, and then selects one or more interventions from a rank-ordered list of possible interventions based on the mode of experience. The controller 50 thereafter controls a state of one or more devices of the autonomous vehicle 10 shown in FIG. 1 to thereby implement the one or more interventions. In this manner, the controller 50 performs the method 100 so as to ultimately affect the mode of experience of the passenger 11, e.g., by supporting, nudging, adjusting, or helping the passenger 11 recover from an abnormal situation as shown in FIGS. 3 and 4.

Commencing with block B102 (“DET (11)”) of FIG. 6, the controller 50 of FIGS. 1 and 2 detects the presence of the passenger 11 within the vehicle interior 14, and possibly determines the identity of the passenger 11. As part of block B102, the sensor 30A of FIG. 2 may detect the weight of the passenger 11 on the vehicle seat 20, e.g., operating as an in-seat scale. The controller 50 may then compare the detected weight to a predetermined weight corresponding to a particular passenger 11. The remaining sensors of the sensor suite 30 could be used to refine such an approach, for instance by detecting a seated height, identifying or characteristic facial features, etc. The method 100 proceeds to block B104 after having identified the passenger 11.

At block B104 (“DET MOE”), the controller 50 next determines the specific mode of experience of the passenger 11 whose presence was detected in block B102. Block B104 is informed by factors influencing the mode of the passenger 11. Representative objective or “real-world” factors include, without being limited to, an environmental context, a road layout, a present dynamic state of the autonomous vehicle 10, occupancy level of the vehicle interior 14, route status, and the experience history of the passenger 11.

With respect to the environment, the controller 50 could look to factors such as weather conditions, noise levels, road type and layout, traffic levels, traffic flow, and the like to assess the overall operating environment. Road type as contemplated herein may include rural, urban, highway, etc., while road layout may entail an assessment of the particular roadway surface (dirt/gravel, smooth pavement, rough pavement, etc.), along with path geometry such as straight, slightly curvy, or tortuous, etc. The dynamic state as contemplated herein may include road speed, braking force/levels, and steering inputs imparting perceptible motion to the autonomous vehicle 10. Occupancy level entails the number and locations of one or more additional passengers 11 within the vehicle interior 14 of FIG. 1, when present. Route status may likewise include traffic levels or patterns, as well as construction activities that may influence the psychological comfort level of the passenger 11. Subjective user-specific factors, which could be determined via a software application (“app”) or offline using a questionnaire in one or more embodiments, may include previous experiences of the passenger 11 as recorded in their user profile, learned, or stated user preferences, post-ride evaluations, age, gender, driving style, prior driving trauma, prior attitudes toward automation, etc.

With respect to experience history, each passenger 11 of the autonomous vehicle 10 of FIG. 1 may have a corresponding user profile. At initial use of the method 100, each user profile may be populated with default data, for instance equally-weighted or nominally-assigned rankings for stimuli that could, alone or in a particular combination, adversely affect the psychological comfort level of the passenger 11. With each successive detection of the passenger 11, the controller 50 may discern the emotional state of the passenger 11 in response to the various conditions or stimuli noted above. Thus, the present approach may entail building and updating multiple user-specific user profiles describing, for each passenger 11 of the autonomous vehicle 10, a mode of experience history that may be accessed by the controller 50 as needed when performing the method 100. In one or more implementations, such user profiles could be constructed for different groups of people, with such groups being segmented by age, gender, driving experience, years since receiving driver license, local residency, etc.

CLASSIFICATION: using the received user data (arrow CC_{I} of FIG. 2), the controller 50 assesses the psychological position/mode of experience of the passenger 11. That is, the controller 50 classifies the passenger 11 as being in one of the above-described modes, i.e., sensory, dichotomous, or complex. As part of this process, the controller 50 may evaluate spoken words or utterances, gestures, and/or context.

Sensory Mode: exemplary words that may be uttered by the passenger 11 in sensory mode, possibly in response to prompts from the controller 50, include “smooth”, “soft”, “calm”, “relaxed”, “comfortable”, and “in control”. Representative gestures include actions such as tapping, pursing lips, stroking hair, or performing other grooming actions, pulling on or twisting hair, playing with, clipping, or biting fingernails, scratching, nodding, or holding a fixed/locked gaze. In terms of context during Sensory Mode, such items could include perception of an immediate threat, body sensations or senses, the passenger 11 talking about themselves as if they were alone, dissociation between a bad situation and a “perfectly calm” experience, or other psychological defensive mechanisms.

Dichotomous Mode: exemplary words that may be uttered by the passenger 11 in this mode may include “extreme”, “evil”, “perfect”, “horrible”, “fantastic”, “awful”, “amazing”, and “believe/trust in.” Representative gestures in this mode may include actions such as using an angry tone or showing impatience. In terms of context during dichotomous mode, this may entail extreme thinking, making excuses for mistakes (e.g., praying or justifying), dismissing good behavior as luck, or otherwise blaming actions on the autonomous vehicle 10.

Complex Mode: exemplary words that may be uttered by the passenger 11 in complex mode include “I wonder”, “Can it?”, “Would it?”, “What if?”, etc. Representative gestures may include not monitoring the road, looking at surrounding scenery, etc. In terms of context during complex mode, this could entail, e.g., attributing the autonomous vehicle 10 with wishes, wants, human reasoning, and the like. The method 100 of FIG. 6 proceeds to block B106 once the mode of experience of the passenger 11 has been determined.

Block B106 (“INT?”), which may be enacted using corresponding logic forming the DMM 51 of FIG. 2, entails determining, via the controller 50 of FIG. 1, whether an intervention is required in order to achieve a particular psychological effect on the passenger 11, such as by moving the passenger 11 to another mode of experience or supporting their current mode. Block B106 may be performed according to predetermined criteria or a past experience history of the passenger 11.

The method 100 proceeds to block B108 when an intervention is required, and repeats block B102 in the alternative when intervention is not required. When in the complex mode of experience, for example, the controller 50 of FIGS. 1 and 2 may determine that the passenger 11 is disengaged from what the vehicle 10 is doing in particular and what is happening around the vehicle 10. The controller 50 could decide to respond to this situation by applying a transient deceleration or driveline jerk to “re-engage” the passenger 11 and make the passenger 11 aware to the fact that the drive process is active and the autonomous vehicle 10 is attempting to negotiate a complex road/traffic situation. Such an action could transition the occupant to the dichotomous mode, at least temporarily.

Block B108 (“[INT]R”) may also be implemented using the DMM 51 of FIG. 2, and may include determining the timing and sequence of possible rank-ordered interventions, and possibly assigning a corresponding rank (subscript “R”) to the various intervention options. Exemplary interventions within the scope of the disclosure may include one or more of the following: vehicle dynamics, e.g., braking, acceleration, and/or steering inputs, speech information such as spoken words or phrases, chimes or other audible signals, visual display filters, interior lighting, or visceral filters, e.g., applying light pressure to the seatbelt 18, tightening cushions of the vehicle seats 20, springing the door handles, applying rhythmic vibrations, etc.

In-cabin systems such as the seatbelts 18, temperature settings, HVAC fan settings, window tinting levels, introduction of a lavender or other user-accepted scent, etc., could likewise be adjusted as part of the method 100 if such adjustments are effective for a particular passenger 11. Individually or collectively, such interventions may be used to transition the passenger 11 between modes, or to maintain or support the present mode of the passenger 11. In broad terms, the various interventions are used to affect an output state of available machine-user interfaces within the vehicle interior 14 of FIG. 1. When performing an abnormal support intervention as noted above, the method 100 may include sounding a mode of experience-specific verbal explanation within the vehicle interior 14. Such an action could be coupled with one or more other actions, such as but not limited to tightening the seatbelt, drastically lowering the speed of the autonomous vehicle 10 following the event, establishing a more conservative gap distance, etc. Such interventions could likewise be rank-ordered in accordance with block B108.

Block B108 may include accessing the memory 54 to examine the lookup table 53 (FIG. 2), which in turn may be populated with rank-ordered intervention options for the particular passenger 11 whose mode is being maintained or adjusted. The user profile noted above preserves a past history of responses of the passenger 11 to different interventions, and thus such interventions may be pre-ranked based on past results. The method 100 proceeds to block B110 once the particular intervention or set of interventions has been determined.

At block B110 (“INT”), the controller 50 of FIG. 1 performs the intervention(s) of block B108. This may entail selecting one or more of the interactions from the lookup table 53 of FIG. 1 according to rank, and then performing the highest-ranked intervention(s) for the particular passenger 11 detected at block B102. Every so often, the DMM 51 could pick up a new intervention that was not applied already, or an intervention having a prior lower rank, in order to check that this receives a better response from what the controller 50 has already computed. The method 100 then proceeds to block B112.

At block B112 (“INT=+?”), the controller 50 of FIG. 1 determines whether the intervention(s) performed in block B110 were effective relative to their intended outcomes. That is, the controller 50 may determine if the one or more interventions succeeded in changing the identified mode of experience of the passenger 11. If the interventions were deemed effective, e.g., by transitioning the passenger 11 from the dichotomous position to the sensory position, the method 100 returns to block B102 and begins anew. The controller 50 could then support the new mode of experience. Alternatively, the method 100 proceeds to block B114 when the intervention(s) performed in block B110 are determined by the controller 50 to have been ineffective relative to their intended outcome.

As part of block B112, the controller 50 may assess a context-based achievement. For instance, “context” may be defined as the driving style, demographics, etc. “Achievement” in this case may be defined mathematically as follows:

Achievement(i,t)=Pr(sₜ≠sₜ₊₁|Context,i)

Acceptability(i,t)=measured by feedback and prior data

Uₜ(i)=f(Achievement(i,t),Acceptability(i,t))

In such an approach, the controller 50 learns Uₜ(i) as the average of utility observed so far, e.g., using a contextual combinatorial multi-armed bandit (MAB) formulation. As appreciated in the art, MAB is a type of problem in which a decision-maker, in this case the DMM 51 of FIG. 2, is required to choose between a number of options (interventions) in order to maximize a reward (utility). The decision-maker receives a reward for each intervention that it chooses. However, the reward is uncertain and depends on the underlying probability distribution of the interventions. The goal of the MAB, therefore, is to choose interventions or combinations thereof in a way that maximizes the expected reward over time. At each step, the controller 50 therefore samples from a combination of intervention mechanisms (i), i.e., (i₁, i₂, i₃, . . . , iₖ), such that utility Uₜ(i) is maximized.

Block B114 (“Adj (R)”) may entail optionally adjusting the respective ranks of the various interventions attempted in block B110, whose individual or combined effectiveness was deemed by the controller 50 in block B112 to have been ineffective. Block B114 could include increasing or decreasing the rank of the various interventions, for instance, in an attempt at producing a different response in the passenger 11 the next time blocks B108 and B110 are performed. The method 100 then repeats block B108 after adjusting the ranks of the various interventions.

The controller 50 and method 100 described above are thus configured to tailor the response of the autonomous vehicle 10 to the present emotional state of the passenger 11. By switching modes of experience in a calculated manner, the controller 50 is able to optimize the psychological comfort and satisfaction of the passenger 11 when experiencing an autonomous drive event. Interventions when used are tailored to the passenger 11, e.g., using the occupant's own user profile. If the passenger 11 prefers a sportier or more aggressive driving style, such a passenger 11 would tend to display calmer or more comfortable emotional responses to dynamic control actions of the autonomous vehicle 10. By employing a characterization strategy to identify the psychological state of the passenger 11, and by employing a decision making element using a predefined protocol to learn the most fitting interventions or combinations thereof and attributes such as time, duration, intensity, modality, or multimodalities, the controller 50 is able to accommodate the expectations of the passenger 11 to the autonomous driving experience. These and other attendant benefits will be readily appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A system comprising:
a device having a computer-controllable function;
a sensor suite configured to collect user data, wherein the user data is descriptive of a present emotional state of a user of the system; and
a controller in communication with the sensor suite, wherein the controller is configured to receive the user data, and in response to the user data to:
classify the present emotional state of the user as an identified mode of experience, wherein the identified mode of experience is one of a plurality of different modes of experience;
select one or more intervening control actions (“interventions”) from a list of possible interventions based on the identified mode of experience; and
control an output state of the device to thereby implement the one or more interventions, and to thereby selectively support or modify the identified mode of experience of the user.

2. The system of claim 1, wherein the system is an autonomous vehicle, the user is a passenger of the autonomous vehicle, and the device is a subsystem or a component of the autonomous vehicle.

3. The system of claim 2, wherein the one or more interventions includes an autonomous drive style of the autonomous vehicle.

4. The system of claim 1, wherein the identified mode of experience is selected from the group consisting of: a sensory mode, a dichotomous mode, and a complex mode.

5. The system of claim 1, wherein the controller is configured to control the output state of the device by changing the one or more interventions when the identified mode of experience has remained unchanged for a calibrated duration.

6. The system of claim 5, wherein the controller is configured to:
determine if changing the one or more interventions succeeded in changing the identified mode of experience into a new mode of experience; and
support the new mode of experience using one or more additional interventions, wherein the new mode of experience is another of the different modes of experience.

7. The system of claim 1, wherein the one or more interventions includes an audible, visible, visceral, and/or tactile interaction with the user.

8. The system of claim 1, wherein the sensor suite includes one or more sensors operable for collecting images of the user, and wherein the controller is configured to process the images of the user through facial recognition software and a reference image library to thereby classify the present emotional state of the user as the identified mode of experience.

9. A method for controlling a system, comprising:
collecting user data using a sensor suite positioned in proximity to a human user of the system, wherein the user data is descriptive of a present emotion state of the human user;
receiving the user data via a controller; and
in response to the user data:
classifying the present emotional state of the user as an identified mode of experience, wherein the identified mode of experience is one of a plurality of different modes of experience;
selecting one or more intervening control actions (“interventions”) from a list of possible interventions based on the identified mode of experience; and
controlling an output state of a device of the system by implementing the one or more interventions, including selectively supporting or modify the identified mode of experience of the user.

10. The method of claim 9, wherein the system is an autonomous vehicle, and wherein selecting the one or more interventions includes selecting an autonomous drive style of the autonomous vehicle.

11. The method of claim 9, wherein classifying the emotional state of the user as the identified mode of experience includes selecting the identified mode of experience from the group consisting of: a sensory mode, a dichotomous mode, and a complex mode.

12. The method of claim 9, further comprising:
determining whether the identified mode of experience has remained unchanged for a calibrated duration; and
controlling the output state of the device by changing the one or more interventions when the identified mode of experience has remained unchanged for a calibrated duration.

13. The method of claim 12, further comprising:
determining if changing the one or more interventions succeeded in changing the identified mode of experience into a new mode of experience; and
in response to the one or more interventions having succeeded in changing the identified mode of experience, supporting the new mode of experience using one or more additional interventions, wherein the new mode of experience is another of the different modes of experience.

14. The method of claim 9, wherein the list of possible interventions is a rank-ordered list in which each respective one of the possible interventions has a corresponding rank, further comprising:
increasing or decreasing the corresponding rank of at least one of the possible interventions in response to the at least one of the possible interventions having respectively succeeded in or failed at changing the identified mode of experience.

15. The method of claim 9, wherein controlling the output state of the device by implementing the one or more interventions includes providing, via the controller, an audible, visible, visceral, and/or tactile interaction with the user.

16. The method of claim 9, further comprising:
collecting images of the user via the sensor suite; and
processing the images of the user via the controller to thereby classify the emotional state of the user as the identified mode of experience.

17. The method of claim 15, wherein selecting the one or more interventions from the list of possible interventions includes using a multi-armed bandit formulation.

18. An autonomous vehicle, comprising:
a vehicle body;
a powertrain system configured to produce a drive torque;
road wheels connected to the vehicle body and the powertrain system, wherein at least one of the road wheels is configured to be rotated by the drive torque from the powertrain system;
a sensor suite arranged configured to collect user data indicative of a present emotional state of a passenger of the autonomous vehicle;
a device having a computer-controllable function; and
a controller in communication with the sensor suite, wherein the controller is configured to receive the user data, and in response to the user data to:
classify the present emotional state of the passenger as an identified mode of experience, wherein the identified mode of experience is selected from the group consisting of: a sensory mode, a dichotomous mode, and a complex mode;
select one or more intervening control actions (“interventions”) from a list of possible interventions based on the identified mode of experience; and
control an output state of the device to thereby implement the one or more interventions, and to thereby selectively support or modify the identified mode of experience of the passenger.

19. The autonomous vehicle of claim 18, wherein the passenger is one of a plurality of potential passengers of the autonomous vehicle, and wherein the controller is configured to maintain and periodically update a corresponding user profile of the potential passengers, the user profile including a user-specific record of past interventions and past modes of experience corresponding thereto.

20. The autonomous vehicle of claim 18, wherein the controller is configured to:
control the output state of the device by changing the one or more interventions when the identified mode of experience has remained unchanged for a calibrated duration;
determine if changing the one or more interventions succeeded in changing the identified mode of experience into a new mode of experience; and
support the new mode of experience using one or more additional interventions, wherein the new mode of experience is another mode of the group, wherein the one or more interventions includes one or more of a powertrain control action, a steering control action, a braking control action, or an audible, visible, visceral, and/or tactile interaction with the passenger.
